(19) United States
(12) Patent Application Publication
(10) Pub. No.: US 2025/0047114 A1
(43) Pub. Date: Feb. 6, 2025

(54) ENERGY STORAGE SYSTEM, POWER CONDITIONER, AND STORAGE BATTERY UNIT

(71) Applicant: KYOCERA CORPORATION, Kyoto-shi (JP)

(72) Inventors: Seiji OKADA, Omihachiman-shi (JP); Kazuaki AZUMA, Yasu-shi (JP); Takanobu NISHIGAI, Hiratsuka-shi (JP)

(21) Appl. No.: 18/783,414

(22) Filed: Jul. 25, 2024

(30) Foreign Application Priority Data
Jul. 31, 2023 (JP) 2023-124951

(51) Int. Cl. H02J 7/00; H01M 50/569; H01M 50/597

(52) U.S. Cl. CPC H02J 7/0034; H01M 50/569; H01M 50/597; H02J 2207/20

(57) ABSTRACT

An energy storage system includes a storage battery unit and a power conditioner. The storage battery unit includes a storage battery, a measuring part, and a connecting switch. The measuring part detects the voltage of the storage battery. The connecting switch is provided between the storage battery and the measuring part. The power conditioner adjusts power. When the connecting switch is in the OFF state, the power conditioner applies a first voltage to the storage battery unit. The OFF state of the connecting switch is maintained when the storage battery unit is determined to be reverse-connected on the basis of a comparison between a measured voltage and the first voltage.

### CROSS REFERENCES TO RELATED APPLICATIONS

The present invention contains subject matter related to Japanese Patent Application No. 2023-124951 filed in the Japan Patent Office on Jul. 31, 2023, the entire contents of which are incorporated herein by reference.

### BACKGROUND OF THE INVENTION

### 1. Field of the Invention

The present disclosure relates to an energy storage system, a power conditioner, and a storage battery unit.

### 2. Description of the Related Art

A storage battery unit including a plurality of secondary battery cells is connected to a power conditioner that performs DC/AC conversion and voltage adjustment between the storage battery unit and load equipment or another power source. When an installation worker installs the storage battery unit and power conditioner, the installation worker could mistake the polarities and connect the storage battery unit and power conditioner in reverse. A reverse connection causes a large current to flow, which could result in damage to the power conditioner, degradation of the storage battery unit, and the like. One proposal of the related art is a power supply apparatus that protects the circuit even in the case of a reverse connection (see Japanese Unexamined Patent Application Publication No. 2013-232995).

### SUMMARY OF THE INVENTION

To address the problems described above, in a first aspect, an energy storage system includes at least one storage battery unit and a power conditioner. The at least one storage battery unit includes a storage battery, a measuring part that detects a voltage of the storage battery, and a connecting switch provided between the storage battery and the measuring part. The power conditioner adjusts power to be inputted to the at least one storage battery unit and power to be outputted from the at least one storage battery unit. When the connecting switch is in an OFF state, a first voltage is applied to the storage battery unit from the power conditioner. The OFF state of the connecting switch is maintained upon determining that the storage battery unit is reverse-connected. The storage battery unit is determined to be reverse-connected on the basis of a comparison between a measured voltage detected by the measuring part and the first voltage.

In a second aspect, a power conditioner is connected to at least one storage battery unit. The power conditioner includes a first controller. The first controller determines whether or not the at least one storage battery unit is reverse-connected on the basis of a comparison between a measured voltage and a first voltage. The measured voltage is acquired from the storage battery unit while the first voltage is applied to the storage battery unit. Upon determining that the storage battery unit is not reverse-connected, the first controller transmits to the storage battery unit a first command for switching a connecting switch of the storage battery unit to an ON state.

In a third aspect, a storage battery unit includes a storage battery, a measuring part, a connecting switch, and a second controller. The measuring part detects the voltage of the storage battery. The connecting switch is provided between the storage battery and the measuring part. The second controller determines whether or not the storage battery unit is reverse-connected when the connecting switch is in an OFF state and the measuring part detects a voltage other than zero. The determination is based on a comparison between a measured voltage detected by the measuring part and a first voltage indicated by voltage information. The voltage information is acquired from a power conditioner connected to the storage battery through the connecting switch. The second controller maintains the connecting switch in the OFF state upon determining that the storage battery unit is reverse-connected.

### BRIEF DESCRIPTION OF THE DRAWINGS

FIG. 1 is a configuration diagram illustrating a schematic configuration of an energy storage system according to the present embodiment; and

FIG. 2 is a flowchart for explaining a reverse connection protection process to be executed by a controller of the power conditioner in FIG. 1.

### DESCRIPTION OF THE PREFERRED EMBODIMENTS

The following refers to the drawings to describe an embodiment of the present disclosure. Of the components illustrated in the drawings below, the same components are denoted with the same signs.

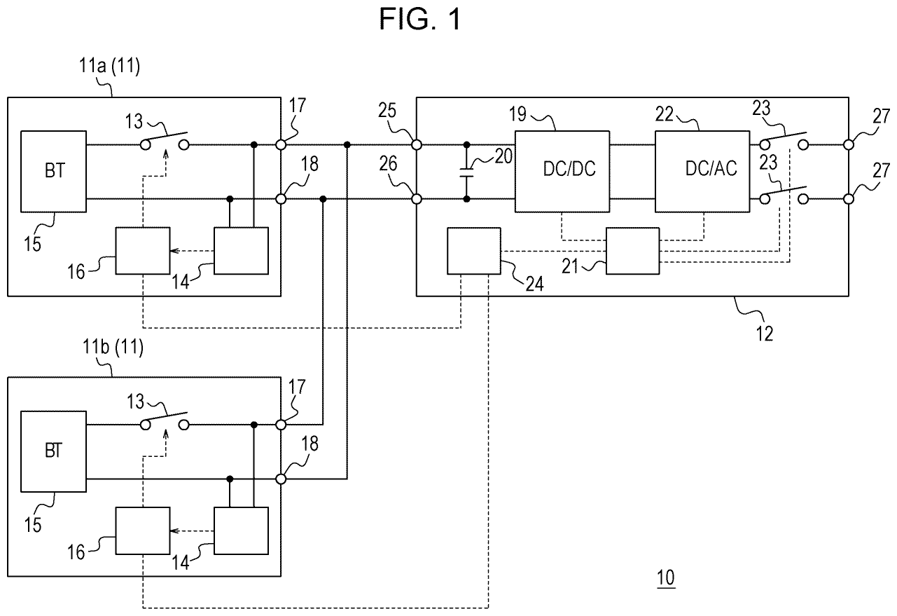

As illustrated in FIG. 1, in one embodiment of the present disclosure, an energy storage system 10 includes at least one storage battery unit 11 and a power conditioner 12. The at least one storage battery unit 11 may be a single storage battery unit 11 or a plurality of storage battery units 11. The energy storage system 10 illustrated in FIG. 1 is described as including two storage battery units 11, namely a first storage battery unit 11a and a second storage battery unit 11b. The following description refers to the first storage battery unit 11a and the second storage battery unit 11b as the storage battery unit 11 when describing features common to both. A plurality of storage battery units 11 may be connected in parallel.

As described later, when a connecting switch 13 of the storage battery unit 11 is in the OFF state, a first voltage is applied to the storage battery unit 11 from the power conditioner 12. In response to the application of the first voltage, the first voltage is compared to a measured voltage detected by a measuring part 14 of the storage battery unit 11. The OFF state of the connecting switch 13 is maintained when the storage battery unit 11 is determined to be reverse-connected on the basis of the comparison between the measured voltage and the first voltage. For example, the power conditioner 12 may determine whether or not the storage battery unit 11 is reverse-connected on the basis of the comparison between the measured voltage and the first voltage.

The storage battery unit 11 includes a storage battery 15, the measuring part 14, the connecting switch 13, and a controller (second controller) 16.

The storage battery 15 includes a single secondary battery cell or a plurality of secondary battery cells. In a configuration with a plurality of secondary battery cells, the plurality of secondary battery cells may be connected in series or parallel. The positive electrode of the storage battery 15 may be connected, directly or indirectly, to a positive electrode terminal 17 of the storage battery unit 11. Specifically, the positive electrode of the storage battery 15 is connected to the positive electrode terminal 17 of the storage battery unit 11 through the connecting switch 13. The negative electrode of the storage battery 15 may be connected, directly or indirectly, to a negative electrode terminal 18 of the storage battery unit 11. Specifically, the negative electrode of the storage battery 15 is connected to the negative electrode terminal 18 of the storage battery unit 11.

The measuring part 14 detects the voltage of the storage battery 15. To detect the voltage of the storage battery 15, a plus terminal of the measuring part 14 may be connected to a first positive electrode terminal 17. The first positive electrode terminal 17 is the positive electrode terminal of the storage battery unit 11. A minus terminal of the measuring part 14 may be connected to a first negative electrode terminal 18. The first negative electrode terminal 18 is the negative electrode terminal of the storage battery unit 11. As described later, the connecting switch 13 is provided between the measuring part 14 and the storage battery 15. Thus, when the connecting switch 13 is in the OFF state, the measuring part 14 may detect the voltage of the first positive electrode terminal 17 and first negative electrode terminal 18. The measuring part 14 is a voltmeter, for example. The lower-limit value of the measurement range of the measuring part 14 may be 0 V or a negative value. The lower-limit value may be at or below the voltage value at which the polarity of a first voltage described later is inverted.

The connecting switch 13 is provided between the storage battery 15 and the measuring part 14. The connecting switch 13 may be provided on the positive electrode side of the storage battery 15, for example. In the OFF state, the connecting switch 13 may interrupt a current. In the ON state, the connecting switch 13 may allow a current to pass. The connecting switch 13 is an electromagnetic relay or a FET, for example.

The controller 16 includes at least one processor, at least one special-purpose circuit, or a combination thereof. The processor is a general-purpose processor, such as a central processing unit (CPU) or a graphics processing unit (GPU), or a special-purpose processor specialized in specific processing. The special-purpose circuit may be a field-programmable gate array (FPGA) or an application-specific integrated circuit (ASIC), for example. The controller 16 controls operations by the storage battery unit 11.

The controller 16 may acquire a measured voltage of the voltage from the measuring part 14 as information, for example. The controller 16 may give the measured voltage of the voltage to the power conditioner 12 as information. In response to giving the measured voltage, the controller 16 may switch the connecting switch 13 to the ON state upon obtaining a first command described later from the power conditioner 12. Note that the controller 16 may keep the connecting switch 13 in the OFF state until the first command is obtained.

The power conditioner 12 adjusts the power to be inputted to at least one storage battery unit 11 and the power to be output from at least one storage battery unit 11. The power conditioner 12 is provided between the storage battery unit 11 and another power source or load equipment, for example. The other power source may supply DC power, as in the case of a photovoltaic generation apparatus or a fuel cell apparatus. The other power source may supply AC power, as in the case of a power grid or a generator. The power conditioner 12 may perform DC/AC conversion as an adjustment of power between load equipment that uses AC power or another power source that supplies AC power and the storage battery unit 11. The power conditioner 12 may adjust the voltage as an adjustment of power between a DC/AC converter 22 described later and the storage battery unit 11.

The power conditioner 12 includes a voltage converter 19 and a capacitor 20. The power conditioner 12 may further include a controller (first controller) 21, the DC/AC converter 22, interconnection relays 23, and a communicator 24.

The voltage converter 19 may adjust the voltage of the power to be supplied to the storage battery unit 11. Specifically, the voltage converter 19 adjusts the voltage at output terminals respectively connected to a second positive electrode terminal 25 and a second negative electrode terminal 26 to a voltage set by the controller 21. The second positive electrode terminal 25 is the positive electrode terminal of the power conditioner 12 connected to the storage battery unit 11. The second negative electrode terminal 26 is the negative electrode terminal of the power conditioner 12 connected to the storage battery unit 11. The voltage converter 19 may adjust the voltage of the power to be supplied to the DC/AC converter 22. The voltage converter 19 is a bidirectional DC/DC converter, for example.

The capacitor 20 is connected in parallel with the voltage converter 19. More specifically, the capacitor 20 is connected to output terminals of the voltage converter 19 connected to the second positive electrode terminal 25 and the second negative electrode terminal 26. The capacitor 20 may be built into the voltage converter 19. The capacitor 20 is a smoothing capacitor, for example.

The DC/AC converter 22 may convert AC power to DC power, and convert DC power to AC power. The DC/AC converter 22 may be connected to the voltage converter 19 on the DC side. The DC/AC converter 22 may be connected to AC terminals 27 on the AC side. The DC/AC converter 22 is a bidirectional DC/AC converter, for example.

The interconnection relays 23 may be provided between the DC/AC converter 22 and the AC terminals 27. In the OFF state, the interconnection relays 23 may interrupt a current. In the ON state, the interconnection relays 23 may allow a current to pass.

The communicator 24 may communicate with the storage battery unit 11 in a wired or wireless way. The communicator 24 may give information and commands to the storage battery unit 11, under control by the controller 21. The communicator 24 may give information acquired from the storage battery unit 11 to the controller 21. The acquired information may be a voltage value measured by the measuring part 14, and may also be a readout of a voltage value recorded in the controller 16.

The controller 21 includes at least one processor, at least one special-purpose circuit, or a combination thereof. The processor is a general-purpose processor, such as a CPU or a GPU, or a special-purpose processor specialized in specific processing. The special-purpose circuit may be an FPGA or an ASIC, for example. The controller 21 controls operations by the power conditioner 12.

When charging the storage battery unit 11, the controller 21 may switch the interconnection relays 23 to the ON state. The controller 21 may control the DC/AC converter 22 to convert AC power to DC power, the AC power being supplied from a power grid connected to the AC terminals 27. The controller 21 may further control the voltage converter 19 to adjust the voltage of DC power outputted from the DC/AC converter 22 to a voltage value for charging the storage battery unit 11. Note that in a configuration in which another power source connected to the power conditioner 12 supplies DC power, the voltage converter 19 may be operated without operating the DC/AC converter 22.

When discharging from the storage battery unit 11, the controller 21 may switch the interconnection relays 23 to the ON state. The controller 21 may further control the voltage converter 19 to adjust the voltage of DC power outputted from the storage battery unit 11 to a voltage value controllable by the DC/AC converter 22. The controller 21 may further control the DC/AC converter 22 to convert DC power to AC power, the DC power being outputted from the voltage converter 19.

When the storage battery unit 11 is electrically connected to the power conditioner 12, the controller 21 may perform a reverse connection protection process. The controller 21 may start the reverse connection protection process when a connection with the storage battery unit 11 is recognized directly or indirectly. The power conditioner 12 may have a predetermined usage method to switch power supply to ON in the state in which the storage battery unit 11 and another power source are electrically connected. The controller 21 may recognize a connection with the storage battery unit 11 when the power supply of the power conditioner 12 is switched to ON. The controller 21 may also recognize a connection with the storage battery unit 11 in response to operation input performed by the installation worker on an input device of the power conditioner 12.

In the reverse connection protection process, when the connecting switch 13 is in the OFF state, the controller 21 controls the voltage converter 19 to bring the voltage of power to be supplied to the storage battery unit 11 to a first voltage, using power supplied from another power source to the voltage converter 19 through the DC/AC converter 22. By adjusting the voltage to the first voltage, the controller 21 applies the first voltage to the storage battery unit 11 connected to the power conditioner 12. The first voltage may be less than a lower-limit value of a working voltage determined for the storage battery unit 11 that is expected to be connected. The lower-limit value of the working voltage is the voltage value at which the controller 16 determines the end of discharge to protect a storage battery from over-discharge. The lower-limit value of the working voltage is, for example, approximately 162 V if the nominal voltage of the storage battery 15 is 200 V. The first voltage may be set to a low voltage such as 10 V to keep inrush current from flowing to the storage battery unit 11 side. The controller 21 may also confirm that the connecting switch 13 of the storage battery unit 11 is not in the ON state as a condition for starting adjustment to the first voltage. The controller 21 may also confirm the absence of a voltage between the second positive electrode terminal 25 and the second negative electrode terminal 26 as a condition for starting adjustment to the first voltage.

The controller 21 acquires a measured voltage as information from the storage battery unit 11 with the first voltage applied. As described above, the measured voltage is the voltage that the measuring part 14 detects between the first positive electrode terminal 17 and the first negative electrode terminal 18. The controller 21 compares the measured voltage and the first voltage, and on the basis thereof, determines whether or not the storage battery unit 11 is reverse-connected to the power conditioner 12. Reverse connection means connecting the terminals of the storage battery unit 11 to the power conditioner 12 with the polarities of terminals reversed.

Specifically, the controller 21 may determine that the storage battery unit 11 is reverse-connected when the difference between the measured voltage and the first voltage is not a determination threshold value or less, or in other words, when the difference exceeds the determination threshold value. The determination threshold value is a value determined to establish a range within which the measured voltage and the first voltage are deemed the same. The controller 21 may determine that the storage battery unit 11 is not reverse-connected when the difference between the measured voltage and the first voltage is the determination threshold value or less. The determination threshold value is a value determined by accounting for the measurement error of the measuring part 14 and the like in the first voltage set below the lower-limit value of the working voltage described above. For example, in a configuration in which the first voltage is set to 10 V, the determination threshold value is 12 V, under the assumption that the measuring part 14 and the controller 21 each have a measurement error of 10%.

Upon determining that the storage battery unit 11 is not reverse-connected, the controller 21 may control the communicator 24 to transmit a first command to the storage battery unit 11. The first command is for switching the connecting switch 13 of the storage battery unit 11 to the ON state.

Upon determining that the storage battery unit 11 is not reverse-connected, the controller 21 may apply to the capacitor 20 a second voltage closer to the working voltage of the storage battery unit 11 than the first voltage, and then switch the connecting switch 13 of the storage battery unit 11 to the ON state. Specifically, upon determining that the storage battery unit 11 is not reverse-connected, the controller 21 controls the voltage converter 19 to bring the voltage of power to be supplied to the storage battery unit 11 to the second voltage, using power supplied from another power source to the voltage converter 19 through the DC/AC converter 22. The second voltage is a value between the first voltage and the working voltage of the storage battery unit 11, and closer to the first voltage. After adjustment to the second voltage, the controller 21 transmits the first command to the storage battery unit 11.

Upon determining that the storage battery unit 11 is not reverse-connected, the controller 21 controls the communicator 24 to transmit the first command to the storage battery unit 11. Upon determining that the storage battery unit 11 is reverse-connected, the controller 21 may control the communicator 24 to transmit a second command to the storage battery unit 11. The second command is for maintaining the connecting switch 13 of the storage battery unit 11 in the OFF state. A danger exists that the controller 16 could switch the connecting switch 13 to the ON state in response to a determination of another condition or a manual operation by the user. On the other hand, reception of the second command may keep the connecting switch 13 from being switched to the ON state by another command. Note that the transmission of the second command may also be omitted in a configuration that has been designed from a safety standpoint to maintain the connecting switch 13 in the OFF state until the storage battery unit 11 receives the first command from the controller 21.

Upon determining that the storage battery unit 11 is reverse-connected, the controller 21 may provide a notification of an abnormal state. For example, the controller 21 may transmit a command for providing a notification of an abnormal state to electronic equipment. The electronic equipment includes output equipment such as a display or speaker connected to the power conditioner 12 in a wired or wireless way. The electronic equipment is the power conditioner 12, a remote control of the power conditioner 12, a home energy management system (HEMS), or an external server, for example.

After a predetermined wait time elapses from the determination that the storage battery unit 11 is reverse-connected, the controller 21 may compare a measured voltage newly acquired from the storage battery unit 11 to the first voltage. The controller 21 may determine again whether or not the storage battery unit 11 is reverse-connected on the basis of the comparison between the measured voltage and the first voltage.

When a plurality of storage battery units 11 are connected to the power conditioner 12 in parallel, the controller 21 may determine whether or not each storage battery unit 11 is reverse-connected to the storage battery unit 11. Specifically, for each of the plurality of storage battery units 11, the controller 21 may determine whether or not that storage battery unit 11 is reverse-connected on the basis of a comparison between a measured voltage measured by the measuring part 14 and the first voltage. Upon determining that a storage battery unit 11 is not reverse-connected from among the plurality of storage battery units 11, the controller 21 may transmit to that storage battery unit 11 the first command for switching the connecting switch 13 of that storage battery unit 11 to the ON state.

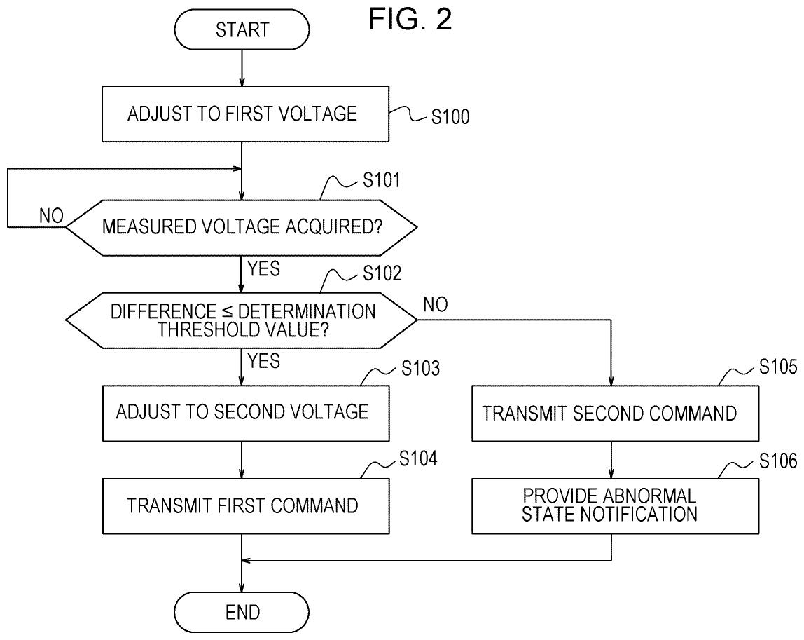

The following uses the flowchart in FIG. 2 to describe the reverse connection protection process executed by the controller 21 in the present embodiment. The reverse connection protection process starts upon recognizing that the storage battery unit 11 has been connected to the power conditioner 12, for example.

In step S100, the controller 21 controls the voltage converter 19 to adjust the voltage of power to be supplied to the storage battery unit 11 to the first voltage. After adjustment of the voltage, the process proceeds to step S101.

In step S101, the controller 21 determines whether or not the measured voltage is acquired from the storage battery unit 11 as information. If the measured voltage is not acquired, the process returns to step S101. If the measured voltage is acquired, the process proceeds to step S102.

In step S102, the controller 21 determines whether or not the difference between the measured voltage confirmed to be acquired in step S101 and the first voltage is the determination threshold value or less. If the difference is the determination threshold value or less, the process proceeds to step S103. If the difference is not the determination threshold value or less, the process proceeds to step S105.

In step S103, the controller 21 controls the voltage converter 19 to adjust the voltage of power to be supplied to the storage battery unit 11 to the second voltage. After adjustment of the voltage, the process proceeds to step S104.

In step S104, the controller 21 controls the communicator 24 to transmit the first command to the storage battery unit 11. After transmission, the reverse connection protection process ends.

In step S105, the controller 21 controls the communicator 24 to transmit the second command to the storage battery unit 11. After transmission, the process proceeds to step S106.

In step S106, the controller 21 controls the communicator 24 to transmit a command for providing a notification of an abnormal state to electronic equipment that includes output equipment. After transmission, the reverse connection protection process ends.

According to the present embodiment configured as above, the energy storage system 10 includes at least one storage battery unit 11 and a power conditioner 12. The at least one storage battery unit 11 includes a storage battery 15, a measuring part 14 that detects the voltage of the storage battery 15, and a connecting switch 13 provided between the storage battery 15 and the measuring part 14. The power conditioner 12 adjusts power to be inputted to the at least one storage battery unit 11 and power to be outputted from the at least one storage battery unit 11. When the connecting switch 13 is in the OFF state, a first voltage is applied to the storage battery unit 11 from the power conditioner 12. The OFF state of the connecting switch 13 is maintained upon determining that the storage battery unit 11 is reverse-connected. The storage battery unit 11 is determined to be reverse-connected on the basis of a comparison between a measured voltage detected by the measuring part 14 and the first voltage. According to such a configuration, the energy storage system 10 may determine a reverse connection before a voltage from the storage battery 15 of the storage battery unit 11 is applied to the power conditioner 12. Consequently, the energy storage system 10 may lower the possibility of damage to the power conditioner 12 due to a reverse connection.

In the energy storage system 10, the power conditioner 12 includes a controller 21. When the difference between the measured voltage and the first voltage is a determination threshold value or less, the controller 21 gives to the storage battery unit 11 a first command for switching the connecting switch 13 to the ON state. According to such a configuration, the energy storage system 10 may make the storage battery unit 11 available for use through the power conditioner 12 when the storage battery unit 11 is connected correctly.

In the energy storage system 10, after the storage battery unit 11 is determined to be reverse-connected, the storage battery unit 11 is again determined to be reverse-connected or not on the basis of a comparison between the measured voltage and the first voltage after a predetermined wait time elapses. According to such a configuration, the energy storage system 10 may connect the storage battery 15 and the power conditioner 12 automatically when a worker, having been notified of an abnormal state, correctly reconnects the storage battery unit 11. Automatic connection is particularly effective for an energy storage system 10 with a plurality of storage battery units 11 connected. For example, rather than forcibly interrupting charging or discharging in progress by the first storage battery unit 11a, the energy storage system 10 may switch the connecting switch 13 to the OFF state when the first storage battery unit 11a stops charging or discharging, and determine whether or not the second storage battery unit 11b is reverse-connected. When the second storage battery unit 11b is not reverse-connected, the energy storage system 10 may give the first command for switching the connecting switch 13 to the ON state to all of the storage battery units 11.

In the energy storage system 10, the first voltage is less than a lower-limit value of a working voltage determined for the storage battery unit 11. According to such a configuration, the first voltage for determining reverse connection is different from a voltage that could be detected for the storage battery 15. Therefore, the energy storage system 10 has improved reverse connection determination accuracy. The energy storage system 10 uses a voltage that is lower than the voltage of the storage battery unit 11, and thus may further reduce the danger of electric shock.

When the difference between the measured voltage and the first voltage exceeds a determination threshold value, the energy storage system 10 provides a notification of an abnormal state. According to such a configuration, the energy storage system 10 may cause a worker installing the energy storage system 10 to recognize a reverse connection, and may encourage the worker to redo the connection correctly.

In the energy storage system 10, the connecting switch 13 is switched to the ON state in a storage battery unit 11 among a plurality of storage battery units 11 that is determined to be reverse-connected on the basis of a comparison between the measured voltage detected by the measuring part 14 and the first voltage. According to such a configuration, the energy storage system 10 can operate using only the correct storage battery units 11 that are not reverse-connected. This enables utilization of the energy storage system 10 using the other, correctly connected storage battery units 11 until the reverse-connected state of the reverse-connected storage battery unit 11 is fixed.

In the energy storage system 10, the power conditioner 12 includes a voltage converter 19 and a capacitor 20. The voltage converter 19 adjusts the voltage of power to be supplied to the storage battery unit 11. The capacitor 20 is connected in parallel with the voltage converter 19. Upon determining that the difference between the measured voltage and the first voltage is the determination threshold value or less, a second voltage closer to the working voltage of the storage battery unit 11 than the first voltage is applied to the capacitor 20, and then the connecting switch 13 is switched to the ON state. According to such a configuration, the energy storage system 10 may reduce the voltage difference between the storage battery unit 11 and the power conditioner 12 before switching the connecting switch 13 to the ON state. Consequently, the energy storage system 10 may establish continuity between the storage battery unit 11 and the power conditioner 12 with a reduced voltage difference between the two, thereby lowering the current value of inrush current between the storage battery unit 11 and the power conditioner 12. Therefore, the energy storage system 10 eliminates the need for the power conditioner 12 to have a circuit for protecting against inrush current, and thus may allow for simplified configuration and a reduction in the number of parts of the power conditioner 12.

In one embodiment, (1) an energy storage system comprises:
at least one storage battery unit including a storage battery, a measuring part that detects a voltage of the storage battery, and a connecting switch provided between the storage battery and the measuring part; and
a power conditioner that adjusts power to be inputted to the at least one storage battery unit and power to be outputted from the at least one storage battery unit, wherein
when the connecting switch is in an OFF state, a first voltage is applied to the storage battery unit from the power conditioner and the OFF state of the connecting switch is maintained upon determining that the storage battery unit is reverse-connected, the storage battery unit being determined to be reverse-connected on the basis of a comparison between a measured voltage detected by the measuring part and the first voltage.

(2) In the energy storage system according to (1), the power conditioner includes a controller that gives to the storage battery unit a first command for switching the connecting switch to an ON state when the difference between the measured voltage and the first voltage is a determination threshold value or less.

(3) In the energy storage system according to (1), the storage battery unit further includes a second controller that switches the connecting switch to the ON state when the difference between the measured voltage and the first voltage is a determination threshold value or less.

(4) In the energy storage system according to any of (1) to (3), after the storage battery unit is determined to be reverse-connected, the storage battery unit is again determined to be reverse-connected or not on the basis of a comparison between the measured voltage and the first voltage after a predetermined wait time elapses.

(5) In the energy storage system according to any of (1) to (4), the first voltage is less than a lower-limit value of a working voltage determined for the storage battery unit.

(6) In the energy storage system according to any of (1) to (5), when the difference between the measured voltage and the first voltage exceeds a determination threshold value, the energy storage system provides a notification of an abnormal state.

(7) In the energy storage system according to any of (1) to (6),
the at least one storage battery unit includes a plurality of storage battery units, and
the connecting switch is switched to the ON state in a storage battery unit among the plurality of storage battery units that is determined to be reverse-connected on the basis of a comparison between the measured voltage detected by the measuring part and the first voltage.

(8) In the energy storage system according to (2) or (3),
the power conditioner includes a voltage converter that adjusts the voltage of power to be supplied to the storage battery unit and a capacitor connected in parallel with the voltage converter, and
when the difference between the measured voltage and the first voltage is the determination threshold value or less, the connecting switch is switched to the ON state after applying to the capacitor a voltage closer to a working voltage of the storage battery unit than the first voltage.

In one embodiment, (9) a power conditioner is connected to at least one storage battery unit, the power conditioner comprising:
a first controller that determines whether or not the at least one storage battery unit is reverse-connected on the basis of a comparison between a measured voltage and a first voltage, the measured voltage being acquired from the storage battery unit while the first voltage is applied to the storage battery unit, and upon determining that the storage battery unit is not reverse-connected, transmits to the storage battery unit a first command for switching a connecting switch of the storage battery unit to an ON state.

In one embodiment, (10) a storage battery unit comprises:
a storage battery;
a measuring part that detects the voltage of the storage battery;
a connecting switch provided between the storage battery and the measuring part; and
a second controller that determines whether or not the storage battery unit is reverse-connected when the connecting switch is in an OFF state and the measuring part detects a voltage other than zero, the determination being based on a comparison between a measured voltage detected by the measuring part and a first voltage indicated by voltage information acquired from a power conditioner connected to the storage battery through the connecting switch, and maintains the connecting switch in the OFF state upon determining that the storage battery unit is reverse-connected.

The foregoing describes embodiments of the energy storage system 10, but in the present disclosure, an embodiment may also be achieved as a method or program for implementing an apparatus, or as a storage medium (such as an optical disc, magneto-optical disc, CD-ROM, CD-R, CD-RW, magnetic tape, hard disk, or memory card, for example) in which a program is recorded.

An embodiment in the form of a program is not limited to an application program such as object code compiled by a compiler or program code to be executed by an interpreter, and may also be in a form such as a program module incorporated into an operating system. The program may or may not be configured so that all processing is performed solely in a CPU on a control board. The program may also be configured to be implemented, in part or in full, by another processing unit mounted on an expansion board or expansion unit added to the board as needed.

The drawings used to describe an embodiment according to the present disclosure are schematic. The dimensional proportions and the like of the drawings do not necessarily match the real proportions.

The foregoing description of embodiments according to the present disclosure is based on the drawings and examples, but note that a person skilled in the art could make various variations or revisions on the basis of the present disclosure. Consequently, it is to be understood that these variations or revisions are included in the scope of the present disclosure. For example, the functions and the like included in each component and the like may be rearranged in logically non-contradictory ways. A plurality of components or the like can be combined into one, or a single component can be divided.

For example, in an embodiment according to the above disclosure, the controller 21 of the power conditioner 12 performs the reverse connection protection process. However, the controller 16 of the storage battery unit 11 may perform the reverse connection protection process. Specifically, when the connecting switch 13 is in the OFF state and the measuring part 14 detects a measured voltage other than zero, the controller 16 may compare that measured voltage with the first voltage. The measuring part 14 detects a voltage other than zero when the first positive electrode terminal 17 and the first negative electrode terminal 18 are connected to electrical equipment such as the power conditioner 12. Therefore, the reverse connection protection process may be started in the storage battery unit 11 on the basis of the detection of a voltage other than zero. The controller 16 may acquire the first voltage as voltage information from the power conditioner 12 connected to the storage battery 15 through the connecting switch 13. The controller 16 may also acquire the first voltage as voltage information in advance, and store the acquired first voltage in a memory. The acquisition of voltage information may be done at the time of factory shipment, in response to an input operation on the input device of the power conditioner 12, or by communication from external equipment. The controller 16 may determine whether or not the storage battery unit 11 is reverse-connected on the basis of a comparison between the measured voltage and the first voltage. Upon determining that the storage battery unit 11 is reverse-connected, the controller 16 may maintain the OFF state of the connecting switch 13. Upon determining that the storage battery unit 11 is not reverse-connected, the controller 16 may control the connecting switch 13 to switch to the ON state.

In the present disclosure, all constituent features described herein and/or all methods or all steps of processes disclosed herein can be combined in any combinations, except for combinations in which these features would be mutually exclusive. Each of the features described in the present disclosure can be replaced by alternative features that work for the same, equivalent, or similar purposes, unless explicitly denied. Therefore, unless explicitly denied, each of the disclosed features is merely one example of a comprehensive series of same or equal features.

An embodiment according to the present disclosure is not limited to any of the specific configurations of the embodiments described above. In the present disclosure, embodiments can be extended to all novel features described herein or combinations thereof, or to all novel methods or processing steps described herein or combinations thereof.

In the present disclosure, qualifiers such as “first” and “second” are identifiers for distinguishing configurations. The numerals denoting the configurations distinguished by qualifiers such as “first” and “second” in the present disclosure are interchangeable. For example, the first direction can interchange the identifiers “first” and “second” with the second direction. The identifiers are interchanged at the same time. The configurations are still distinguished after the interchange of the identifiers. The identifiers may be removed. The configurations with the identifiers removed therefrom are distinguished by signs. The description of identifiers such as “first” and “second” in the present disclosure shall not be used as a basis for interpreting the order of the configurations or the existence of identifiers with smaller numbers.

What is claimed is:

1. An energy storage system comprising:
at least one storage battery unit including a storage battery, a measuring part that detects a voltage of the storage battery, and a connecting switch provided between the storage battery and the measuring part; and
a power conditioner that adjusts power to be inputted to the at least one storage battery unit and power to be outputted from the at least one storage battery unit, wherein
when the connecting switch is in an OFF state, a first voltage is applied to the storage battery unit from the power conditioner and the OFF state of the connecting switch is maintained upon determining that the storage battery unit is reverse-connected, the storage battery unit being determined to be reverse-connected on the basis of a comparison between a measured voltage detected by the measuring part and the first voltage.

2. The energy storage system according to claim 1, wherein the power conditioner includes a controller that gives to the storage battery unit a first command for switching the connecting switch to an ON state when the difference between the measured voltage and the first voltage is a determination threshold value or less.

3. The energy storage system according to claim 1, wherein the storage battery unit further includes a second controller that switches the connecting switch to the ON state when the difference between the measured voltage and the first voltage is a determination threshold value or less.

4. The energy storage system according to claim 1, wherein after the storage battery unit is determined to be reverse-connected, the storage battery unit is again determined to be reverse-connected or not on the basis of a comparison between the measured voltage and the first voltage after a predetermined wait time elapses.

5. The energy storage system according to claim 1, wherein the first voltage is less than a lower-limit value of a working voltage determined for the storage battery unit.

6. The energy storage system according to claim 1, wherein when the difference between the measured voltage and the first voltage exceeds a determination threshold value, the energy storage system provides a notification of an abnormal state.

7. The energy storage system according to claim 1, wherein
the at least one storage battery unit includes a plurality of storage battery units, and
the connecting switch is switched to the ON state in a storage battery unit among the plurality of storage battery units that is determined to be reverse-connected on the basis of a comparison between the measured voltage detected by the measuring part and the first voltage.

8. The energy storage system according to claim 2, wherein
the power conditioner includes a voltage converter that adjusts the voltage of power to be supplied to the storage battery unit and a capacitor connected in parallel with the voltage converter, and
when the difference between the measured voltage and the first voltage is the determination threshold value or less, the connecting switch is switched to the ON state after applying to the capacitor a voltage closer to a working voltage of the storage battery unit than the first voltage.

9. A power conditioner connected to at least one storage battery unit, the power conditioner comprising:
a first controller that determines whether or not the at least one storage battery unit is reverse-connected on the basis of a comparison between a measured voltage and a first voltage, the measured voltage being acquired from the storage battery unit while the first voltage is applied to the storage battery unit, and upon determining that the storage battery unit is not reverse-connected, transmits to the storage battery unit a first command for switching a connecting switch of the storage battery unit to an ON state.

10. A storage battery unit comprising:
a storage battery;
a measuring part that detects the voltage of the storage battery;
a connecting switch provided between the storage battery and the measuring part; and
a second controller that determines whether or not the storage battery unit is reverse-connected when the connecting switch is in an OFF state and the measuring part detects a voltage other than zero, the determination being based on a comparison between a measured voltage detected by the measuring part and a first voltage indicated by voltage information acquired from a power conditioner connected to the storage battery through the connecting switch, and maintains the connecting switch in the OFF state upon determining that the storage battery unit is reverse-connected.
